(19) United States
(12) Patent Application Publication
(10) Pub. No.: US 2015/0008107 A1
(43) Pub. Date: Jan. 8, 2015

(54) SWITCH DEVICE

(71) Applicant: KABUSHIKI KAISHA TOKAI RIKA DENKI SEISAKUSHO, Aichi (JP)

(72) Inventors: Motoya TAKEUCHI, Aichi (JP); Takayasu MUTO, Aichi (JP); Katsutoshi TERAKAWA, Aichi (JP)

(21) Appl. No.: 14/310,494

(22) Filed: Jun. 20, 2014

(30) Foreign Application Priority Data
Jul. 4, 2013 (JP) 2013-140621

(51) Int. Cl. H01H 1/58

(52) U.S. Cl. CPC H01H 1/5844; H01H 2235/024
USPC 200/283

(57) ABSTRACT

A switch device includes a terminal and a leaf spring supported by the terminal. The leaf spring is resiliently movable to produce a contact action. The leaf spring includes a metal plating applied to a portion that is in contact with and supported by the terminal. The metal plating is not applied to a portion of the leaf spring where stress concentrates when the leaf spring is resiliently moved.

### CROSS-REFERENCE TO RELATED APPLICATIONS

This application is based upon and claims the benefit of priority from prior Japanese Patent Application No. 2013-140621, filed on Jul. 4, 2013, the entire contents of which are incorporated herein by reference.

### FIELD

The present invention relates to a switch device that resiliently moves a leaf spring to produce a contact action.

### BACKGROUND

Japanese Laid-Open Patent Publication No. 7-65681 describes a switch device referred to as a snap action module switch. The switch device resiliently moves a leaf spring to produce a contact action. In this structure, contacts open and close quickly and stably. This shortens the duration of arcs and prolongs the life of the switch.

In the switch device, the leaf spring is supported by a terminal. Thus, the leaf spring constantly contacts the terminal. However, the contact action causes abrasion at the portion of contact between the leaf spring and the terminal. This forms abrasive particles. Oxidation of the abrasive particles generates electric resistance that destabilizes the electric connection. To delay such oxidation, the above publication describes the application of silver plating to the leaf spring. However, the application of silver plating to portions of the leaf spring where stress concentrates adversely affects anti-fatigue properties.

### SUMMARY

The present invention provides a switch device capable of delaying the oxidation of abrasive grains while limiting deterioration of the anti-fatigue properties of a leaf spring.

A first aspect of the present invention is a switch device including a terminal and a leaf spring supported by the terminal. The leaf spring is resiliently movable to produce a contact action. The leaf spring includes a metal plating applied to a portion that is in contact with and supported by the terminal, and the metal plating is not applied to a portion of the leaf spring where stress concentrates when the leaf spring is resiliently moved.

A second aspect of the present invention is a switch device including a terminal and a leaf spring supported by the terminal. The leaf spring is resiliently movable to produce a contact action. The leaf spring includes a metal plating applied to only a portion that is in contact with and supported by the terminal.

A third aspect of the present invention is a leaf spring applied to a switch device and resiliently movable to produce a contact action. The leaf spring includes a metal plating applied to a portion that is in contact with and supported by a terminal of the switch device. The metal plating is not applied to a portion of the leaf spring where stress concentrates when the leaf spring is resiliently moved.

A fourth aspect of the present invention is a leaf spring applied to a switch device and resiliently movable to produce a contact action. The leaf spring includes a metal plating applied to only a portion that is in contact with and supported by a terminal of the switch device.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view of a power window switch;

FIG. 2 is a cross-sectional view of the power window switch during a DOWN operation;

FIG. 3 is an electric circuit diagram of the power window switch;

FIG. 4 is a table illustrating the connection of terminals for each position;

FIG. 5 is a plan view of a leaf contact;

FIG. 6 is an enlarged view of encircled portion P in FIG. 1;

FIG. 7 is an enlarged view of encircled portion Q in FIG. 1; and

FIG. 8 is a cross-sectional view of the power window switch illustrating a conductive line during a DOWN operation.

### DESCRIPTION OF THE EMBODIMENTS

One embodiment of a switch device will now be described.

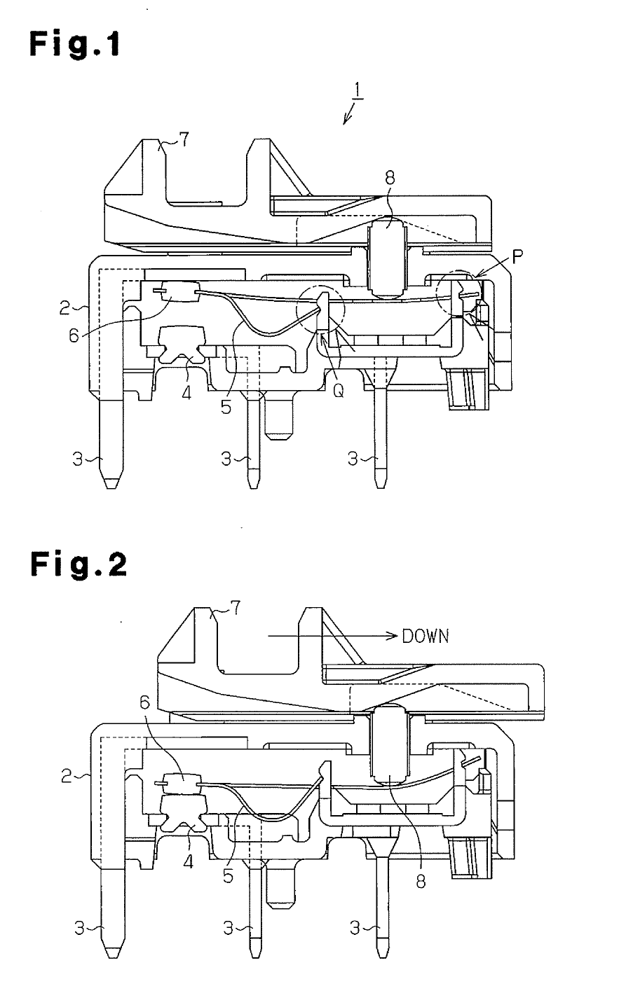

FIG. 1 illustrates a power window switch 1, which is one example of a switch device. The power window switch 1 includes an insulator 2, which serves as a support base. A plurality of (four in the present example) terminals 3 are coupled to the insulator 2. FIG. 1 illustrates three of the four terminals 3. A fixed contact 4 is connected to a specific one of the four terminals 3. In the present example, the four terminals 3 are an UP terminal, a DN terminal, an IG terminal, and an E terminal. The UP terminal is related with a lifting motion (UP motion) for closing a door window. The DN terminal is related with a lowering motion (DOWN motion) for opening the door window. The IG terminal is connected to a high potential, and the E terminal is connected to a low potential. In the present example, the IG terminal is used as the specific terminal 3.

The insulator 2 includes a cavity that accommodates a leaf contact (not illustrated), which is supported by the UP terminal, and a leaf contact 5, which is supported by the DN terminal. Each leaf contact is movable in the cavity independently from the other leaf contact. The leaf contact 5 illustrated in FIG. 1 will now be described. As viewed in FIG. 1, the DN terminal 3 is located at the rightmost side, and the E terminal 3 is located at the leftmost side. The DN terminal 3 is branched into two upwardly extending distal ends, one at the left and the other at the right. As illustrated in the two encircled portion P and Q, the leaf contact 5 is supported by the two distal ends of the DN terminal 3. The leaf contact 5 includes a movable contact 6 resiliently moved between a position where the movable contact 6 is connected to the E terminal 3 and a position where the movable contact 6 is connected to the fixed contact 4. In this manner, the leaf contact 5 is supported by the DN terminal 3 to produce a contact action. The leaf contact 5 is one example of a leaf spring.

A slider (not illustrated) is arranged on the upper portion of the insulator 2 to generate an UP motion command when moved. A slider 7 is also arranged on the upper portion of the insulator 2 to generate a DOWN motion command when moved. Each slider is movable independently from the other slider. A pusher (not illustrated) moves in cooperation with the slider that generates the UP motion command, and a pusher 8 moves in cooperation with the slider 7 that generates the DOWN motion command. Each pusher constantly contacts the corresponding leaf contact 5 and moves in the vertical direction in accordance with the movement of the corresponding slider. For example, as viewed in FIG. 1, rightward movement of the slider 7 lowers the pusher 8 and produces an action of the leaf contact 5 (movable contact 6).

Referring to FIG. 2, when the pusher 8 is lowered, the force accumulated in the leaf contact 5 is released. This moves the movable contact 6 from the position electrically connected to the leftmost E terminal 3 as illustrated in FIG. 1 to the position electrically connected to the fixed contact 4 (i.e., the middle IG terminal 3).

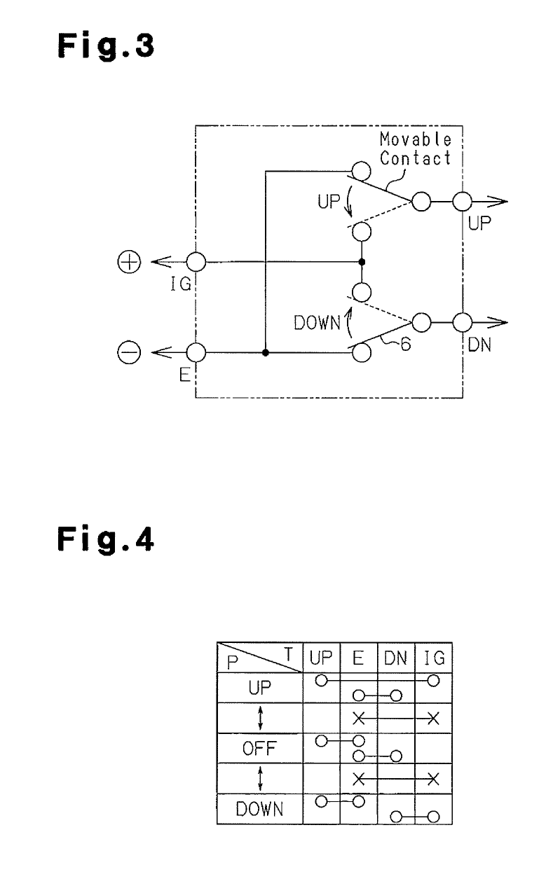

Referring to FIG. 3, when an UP motion command is generated, the movable contact of the leaf contact is moved from the position electrically connected to the E terminal to the position electrically connected to the IG terminal. This outputs an UP motion command signal from the UP terminal that is used by a downstream circuit to control an UP motion. In the same manner, when a DOWN motion command is generated, the movable contact 6 of the leaf contact 5 is moved from the position electrically connected to the E terminal to the position electrically connected to the IG terminal (refer to FIG. 2). This outputs a DOWN motion command signal from the DN terminal that is used by a downstream circuit to control a DOWN motion.

Referring to FIG. 4, when neither an UP motion nor a DOWN motion are produced, that is, when the sliders are both located at an OFF position, the UP terminal is connected to the E terminal, and the DN terminal is connected to the E terminal. When the slider that generates an UP motion command is moved from the OFF position to an UP position, the UP terminal is connected to the IG terminal. In this case, the DN terminal remains connected to the E terminal. When the slider 7 that generates a DOWN motion command is moved from the OFF position (FIG. 1) to a DOWN position (FIG. 2), the DN terminal is connected to the IG terminal. In this case, the UP terminal remains connected to the E terminal. In each of these processes, the E terminal and the IG terminal are not connected to each other.

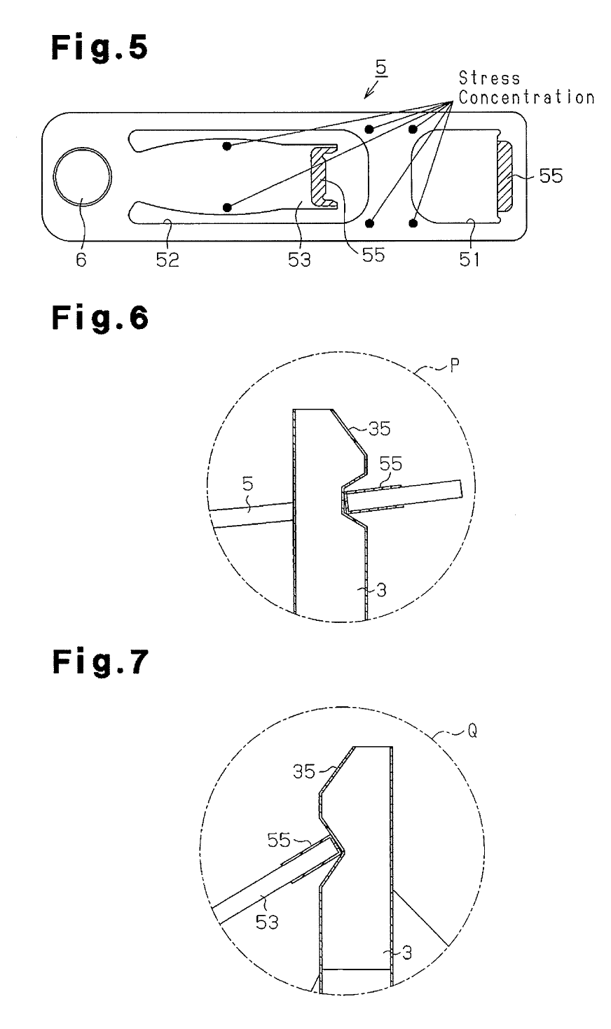

The structure of the leaf contact 5 will now be described with reference to FIG. 5. The two leaf contacts are identical in structure. Thus, only the leaf contact 5 will be described below. The leaf contact 5 is formed by, for example, performing metal processing on a thin plate of spring material made of beryllium copper. The leaf contact 5 has an elongated shape and includes an engagement hole 51 located proximal to the right longitudinal end. One distal end (first distal end) of the DN terminal 3 is inserted through the engagement hole 51. A right wall defining the engagement hole 51 is supported by the first distal end of the DN terminal 3 (refer to encircled portion P in FIG. 1). The leaf contact 5 also includes an elongated hole 52, which is separated in the longitudinal direction from the engagement hole 51. The other distal end (second distal end) of the DN terminal 3 is inserted through the elongated hole 52. A spring piece 53 extends from a left wall defining the elongated hole 52. The spring piece 53 is movable in the elongated hole 52. The spring piece 53 includes a distal wall supported by the second distal end of the DN terminal 3 (refer to encircled portion Q in FIG. 1). The portion extending between the engagement hole 51 and the elongated hole 52 is a region that the pusher 8 contacts. The movable contact 6 is coupled near the left end of the leaf contact 5.

As illustrated in FIG. 6, the leaf contact 5 includes a silver plating 55 applied to the right wall of the engagement hole 51 and a portion adjacent to the right wall (refer to hatching lines in FIG. 5). Further, the DN terminal 3 includes a silver plating 35 applied to the surface of the first distal end that supports the leaf contact 5 (portion where silver plating 55 is applied).

As illustrated in FIG. 7, the leaf contact 5 also includes a silver plating 55 applied to the distal wall of the spring piece 53 and a portion adjacent to the distal wall (refer to hatching lines in FIG. 5). The DN terminal 3 also includes a silver plating 35 applied to the surface of the second distal end that supports the leaf contact 5 (portion where silver plating 55 is applied). In this manner, the leaf contact 5 includes the silver plating 55 at portions (two locations in the present example) that are in contact with and supported by the DN terminal 3.

The silver plating 55 is not applied to the leaf contact 5 at portions where stress concentrate when the stored force is released (refer to dots in FIG. 5). In other words, the silver plating 55 is applied to the leaf contact 5 only at portions that contact the DN terminal 3. That is, the silver plating 55 is applied to the leaf contact 5 at portions that are in contact with and supported by the DN terminal 3 and free of stress concentration when the leaf contact 5 is resiliently moved.

A process for manufacturing the leaf contact 5 will now be described.

First, a pressing process is performed on a metal spring material to shape a leaf spring. Then, a plating process is performed to apply the silver plating 55 to portions of the surfaces cut in the pressing process that are in contact with and supported by the DN terminal 3 and portions adjacent to such cut surfaces. Subsequently, the movable contact 6 is coupled to the spring material, and a bending process is performed to set a predetermined spring constant for the spring piece 53.

The operation of the power window switch 1 will now be described.

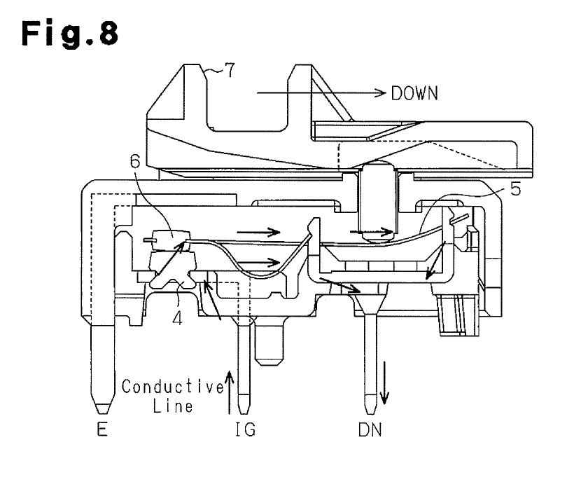

Referring to FIG. 8, when the slider 7 is moved to generate a DOWN motion, the leaf contact 5 which is supported by the DN terminal resiliently moves and produces a contact action that connects the movable contact 6 to the fixed contact 4. This forms a conductive line extending from the IG terminal to the DN terminal via the fixed contact 4 and the movable contact 6. The conductive line is separated into two lines in conformance with the shape of the leaf contact 5 but is ultimately joined at the DN terminal. The silver plating 35 and 55 (refer to FIGS. 5 to 7) are applied to the portions of the leaf contact 5 and the DN terminal that are in contact with each other. This lowers the electric resistance and stabilizes the electrical connection at such portions of contact. Abrasion may occur at the portions of contact and produce abrasive particles. However, the abrasive particles would be formed from the silver plating 35 and 55. This lowers the rate of oxidation. Further, silver plating is not applied to portions of the leaf contact 5 where stress concentrates. This limits deterioration of the anti-fatigue properties.

The present embodiment has the advantages described below.

(1) The silver plating 55 is partially applied to the leaf contact 5. This limits deterioration of the anti-fatigue properties and delays oxidation of abrasive particles.

(2) Since deterioration of the anti-fatigue properties is limited, durability may be improved in the leaf contact 5 that repetitively produces the contact action.

(3) Silver plating 35 and 55 is applied to the portions of the leaf contact 5 and the DN terminal 3 that are in contact with each other. In such a structure, silver is in contact with silver. This lowers the electric resistance and stabilizes the electrical connection.

(4) The electric resistance is low. This reduces Joule heating during the passage of current.

It should be apparent to those skilled in the art that the present invention may be embodied in many other specific forms without departing from the spirit or scope of the invention. Particularly, it should be understood that the present invention may be embodied in the following forms.

The metal plating applied to the leaf contact 5 may be a gold plating instead of the silver plating 35.

The metal plating applied to the DN terminal 3 may be a gold plating instead of the silver plating 55.

The metal plating of the leaf contact 5 and the metal plating of the DN terminal 3 may be formed from the same metal material or a different metal material.

In the above embodiment, the power window switch 1 is illustrated as an example of a switch device. However, the present invention may be applied to any switch device that resiliently moves a leaf spring supported by a terminal to produce a contact action. Further, the present invention is not limited to a switch device that is used in a vehicle. Moreover, the present invention is not limited to a switch device that produces two motions (UP motion and DOWN motion) like in the above embodiment.

This disclosure encompasses a method for manufacturing a leaf spring, in which the leaf spring is configured to supported by a terminal and resiliently movable to produce a contact action. The method includes performing a pressing process on a metal spring material, and applying metal plating to a cut surface of the spring material formed in the pressing process. The step of applying includes applying metal plating to only a portion of the cut surface that is in contact with and supported by the terminal.

The present examples and embodiments are to be considered as illustrative and not restrictive, and the invention is not to be limited to the details given herein, but may be modified within the scope and equivalence of the appended claims.

1. A switch device comprising:
a terminal; and
a leaf spring supported by the terminal, wherein the leaf spring is resiliently movable to produce a contact action,
wherein the leaf spring includes a metal plating applied to a portion that is in contact with and supported by the terminal, and the metal plating is not applied to a portion of the leaf spring where stress concentrates when the leaf spring is resiliently moved.

2. A switch device comprising:
a terminal; and
a leaf spring supported by the terminal, wherein the leaf spring is resiliently movable to produce a contact action,
wherein the leaf spring includes a metal plating applied to only a portion that is in contact with and supported by the terminal.

3. The switch device according to claim 1, wherein the terminal includes a metal plating applied to a portion that supports the leaf spring.

4. A leaf spring for use with a switch device and resiliently movable to produce a contact action, the leaf spring comprising a metal plating applied to a portion that is in contact with and supported by a terminal of the switch device, wherein the metal plating is not applied to a portion of the leaf spring where stress concentrates when the leaf spring is resiliently moved.

5. A leaf spring for use with a switch device and resiliently movable to produce a contact action, the leaf spring comprising a metal plating applied to only a portion that is in contact with and supported by the terminal.
